(19) United States
(12) Patent Application Publication
(10) Pub. No.: US 2025/0038951 A1
(43) Pub. Date: Jan. 30, 2025

(54) ENCRYPTION DEVICE, DECRYPTION DEVICE, CRYPTOGRAPHIC SYSTEM, ENCRYPTION METHOD, AND DECRYPTION METHOD

(71) Applicant: NEC Corporation, Tokyo (JP)

(72) Inventors: Iori FURUYA, Tokyo (JP); Akiko Mukai, Tokyo (JP); Kazuhiko Minematsu, Tokyo (JP)

(73) Assignee: NEC Corporation, Tokyo (JP)

(21) Appl. No.: 18/782,136

(22) Filed: Jul. 24, 2024

(30) Foreign Application Priority Data
Jul. 27, 2023 (JP) 2023-122432

(51) Int. Cl. H04L 9/06

(52) U.S. Cl. CPC H04L 9/0618

(57) ABSTRACT

An encryption device generates a sequence of blocks by dividing data to be encrypted into blocks of fixed length, performs encryption using a block cipher for each block in the sequence of blocks into which the data to be encrypted is divided, and concatenates the encrypted blocks to generate encrypted data, and generates a tag for each block set, which is a combination of blocks included in the sequence of blocks into which the data to be encrypted is divided, and concatenates the tags for each block set to generate a tag for the encrypted data.

This application is based upon and claims the benefit of priority from Japanese patent application No. 2023-122432, filed on Jul. 27, 2023, the disclosure of which is incorporated herein in its entirety by reference.

### TECHNICAL FIELD

The present disclosure relates to an encryption device, a decryption device, a cryptographic system, an encryption method, and a decryption method.

### BACKGROUND ART

Authentication encryption techniques for detecting the presence of tampering with encrypted data have been proposed (see, for example, Patent Document 1 (Japanese Unexamined Patent Application Publication No. 2016-075765)).

### SUMMARY

It is desirable to be able to detect not only the presence or absence of tampering with encrypted data, but also the location of the tampering if tampering has occurred.

An example of an object of the present disclosure is to provide an encryption device, decryption device, cryptographic system, encryption method, decryption method, and program that can solve the above-mentioned problems.

According to a first example aspect of the present disclosure, an encryption device includes a blocking means that generates a sequence of blocks by dividing data to be encrypted into blocks of fixed length; an encryption means that performs encryption using a block cipher for each block in the sequence of blocks into which the data to be encrypted is divided, and concatenates the encrypted blocks to generate encrypted data; and a tag generation means that generates a tag for each block set, which is a combination of blocks included in the sequence of blocks into which the data to be encrypted is divided, and concatenates the tags for each block set to generate a tag for the encrypted data.

According to the second example aspect of the present disclosure, a decryption device includes a blocking means that generates a sequence of blocks by dividing data to be decrypted into blocks of fixed length; a decryption means that decrypts each block included in the sequence of blocks into which the data to be decrypted has been divided, using a block cipher, and concatenates the decrypted blocks to generate decrypted data; a tag generation means that generates a tag for each block set in which the blocks included in the decrypted block sequence are combined, and concatenates the tags for each block set to generate a tag for the data to be decrypted; and a verification means that detects the presence or absence of tampering in the data to be decrypted and the location of the tampering in a case where tampering is detected, based on the tags generated by the tag generation means and the tags generated during encryption.

According to the third example aspect of the present disclosure, an encryption system includes an encryption device and a decryption device, wherein the encryption device comprises: an encryption-side blocking means that generates a sequence of blocks by dividing data to be encrypted into blocks of fixed length; an encryption means that performs encryption using a block cipher for each block in the sequence of blocks into which the data to be encrypted is divided, and concatenates the encrypted blocks to generate encrypted data; and an encryption-side tag generation means that generates a tag for each first block set, which is a block set that is a combination of blocks included in a sequence of blocks into which the data to be encrypted is divided, and concatenates the tags for each first block set to generate a tag for the encrypted data, and the decryption device comprises: a decryption-side blocking means that generates a sequence of blocks by dividing data to be decrypted into blocks of fixed length; a decryption means that decrypts each block included in the sequence of blocks into which the data to be decrypted has been divided, using a block cipher, and concatenates the decrypted blocks to generate decrypted data; a decryption-side tag generation means that generates a tag for each second block set, which is a block set that is a combination of blocks included in the decrypted block sequence, and concatenates the tags for each second block set to generate a tag for the data to be decrypted; and a verification means that detects the presence or absence of tampering in the data to be decrypted and the location of the tampering in a case where tampering is detected, based on the tag of the data to be decrypted and the tag of the encrypted data.

According to the fourth example aspect of the present disclosure, an encryption method includes the steps of an encryption device: generating a sequence of blocks by dividing data to be encrypted into blocks of fixed length; performing encryption using a block cipher for each block in the sequence of blocks into which the data to be encrypted is divided; concatenating the encrypted blocks to generate encrypted data; generating a tag for each block set in which the blocks included in the sequence of blocks into which the data to be encrypted is divided are combined; and concatenating the tags for each block set to generate tags of the encrypted data.

According to the fifth example aspect of the present disclosure, a decryption method includes the steps of a decryption device: generating a sequence of blocks by dividing data to be decrypted into blocks of fixed length; performing decryption using a block cipher for each block in the sequence of blocks into which the data to be decrypted is divided; concatenating the decrypted blocks to generate decrypted data; generating a tag for each block set in which the blocks included in the sequence of decrypted blocks are combined; and concatenating the tags for each block set to generate tags for the data to be decrypted, and based on the tags for the data to be decrypted and tags generated during encryption, detecting the presence or absence of tampering in the data to be decrypted and the tampering location in a case where tampering is detected.

According to the sixth example aspect of the present disclosure, a program is one that causes a computer to execute the steps of: generating a sequence of blocks by dividing data to be encrypted into blocks of fixed length, and performing encryption using a block cipher for each block in the sequence of blocks into which the data to be encrypted is divided; concatenating the encrypted blocks to generate encrypted data; generating a tag for each block set in which the blocks included in the sequence of blocks into which the data to be encrypted is divided are combined; and concatenating the tags for each block set to generate tags of the encrypted data.

According to the seventh example aspect of the present disclosure, a program is one that causes a computer to execute the steps of: generating a sequence of blocks by dividing data to be decrypted into blocks of fixed length; performing decryption using a block cipher for each block in the sequence of blocks into which the data to be decrypted is divided, and concatenating the decrypted blocks to generate decrypted data; generating a tag for each block set in which the blocks included in the sequence of decrypted blocks are combined; concatenating the tags for each block set to generate tags of the decrypted data; and detecting the presence or absence of tampering in the data to be decrypted and the tampering location in a case where tampering is detected based on the tag of the data to be decrypted and the tag generated during encryption.

According to the present disclosure, in a case where encrypted data has been tampered with, the tampering location can be detected.

### BRIEF DESCRIPTION OF THE DRAWINGS

FIG. 1 is a drawing that shows an example of the configuration of a cryptographic system according to at least one example embodiment.

FIG. 2 is a drawing that shows an example of the configuration of an encryption device according to at least one example embodiment.

FIG. 3 is a drawing that shows an example of data flow in a case where the encryption device of at least one example embodiment encrypts plain text.

FIG. 4 is a drawing that shows an example of data flow in a case where the encryption device of at least one example embodiment generates tags using encrypted blocks.

FIG. 5 is a drawing that shows an example of the configuration of a decryption device according to at least one example embodiment.

FIG. 6 is a drawing that shows an example of data flow in a case where a decryption device according to at least one example embodiment decrypts ciphertext.

FIG. 7 is a drawing that shows another example of the configuration of an encryption device according to at least one example embodiment.

FIG. 8 is a drawing that shows another example of the configuration of a decryption device according to at least one example embodiment.

FIG. 9 is a drawing that shows another example of the configuration of the cryptographic system according to at least one example embodiment.

FIG. 10 is a drawing that shows an example of the processing steps in the encryption method according to at least one example embodiment.

FIG. 11 is a drawing that shows an example of the processing steps in the decryption method according to at least one example embodiment.

FIG. 12 is a schematic block diagram showing the configuration of a computer according to at least one example embodiment.

### EXAMPLE EMBODIMENT

The following is a description of the example embodiments of the present disclosure with reference to the drawings. However, the disclosure is not limited by the example embodiments described below. In each drawing, identical or corresponding elements are labelled with the same reference numerals as appropriate. Furthermore, it should be noted that the drawings are schematic and so the dimensional relationships and proportions of each element may differ from those of actual objects. Even among drawings, there may be parts that have different dimensional relationships and proportions to each other.

In the following, a character marked with a tilde (˜) may be indicated with a superscript tilde following the character. For example, E with a tilde over it is also denoted as E.

In some cases, a letter with a circumflex (\hat{ }) may be indicated with a superscript circumflex following the letter. For example, T with a circumflex over it is also denoted as TA.

### First Example Embodiment

FIG. 1 is a drawing that shows an example of the configuration of a cryptographic system according to at least one example embodiment. In the configuration shown in FIG. 1, a cryptographic system 1 is provided with an encryption device 10 and a decryption device 20.

The cryptographic system 1 encrypts and decrypts data. Furthermore, the cryptographic system 1 detects whether or not the encrypted data has been tampered with, and if tampering is detected, detects the tampering location (the position where the tampering took place).

The encryption device 10 encrypts the data to be encrypted. The encryption device 10 also generates tags to detect tampering with the encrypted data. Tags for detecting tampering (tags for tamper detection) are also referred to as authentication tags or simply tags.

In particular, the encryption device 10 divides the data to be encrypted into blocks of fixed length, encrypts each block, and concatenates the encrypted blocks to produce encrypted data. The encryption device 10 generates tags for each combination of blocks and concatenates the generated tags to generate tags for the encrypted data.

A block (into which data is divided) is also referred to as a data block. A combination of blocks is also referred to as a block set (block aggregate).

The encryption device 10 may be configured using a computer such as a personal computer (PC) or a workstation (WS), for example. Alternatively, the encryption device 10 may be configured using dedicated hardware, such as configured using an Application Specific Integrated Circuit (ASIC) or Field Programmable Gate Array (FPGA).

The decryption device 20 decrypts the encrypted data. The decryption device 20 generates tags using the decrypted data, and detects tampering with the encrypted data using the generated tags and the tags generated by the encryption device 10 (the tags obtained by the decryption device 20).

In particular, the decryption device 20 divides the decrypted data into blocks of fixed length, decrypts each block, and concatenates the decrypted blocks to produce decrypted data. The decryption device 20 generates tags for detection for each combination of decrypted blocks and concatenates the generated tags to generate tags for the encrypted data (data to be decrypted).

In this way, the cryptographic system 1 can generate tags for a block set and perform tamper detection to detect whether or not the blocks in that block set have been tampered with. In particular, if the cryptographic system 1 generates tags for each block set determined in such a way that the blocks can be identified, such as by generating tags for each block set determined using the Combinatorial Group Testing (CGT) method, in order to detect tampering on a block-by-block basis. As a result, in a case where the cryptographic system 1 detects tampering with encrypted data, the tampering location can be detected block by block.

The decryption device 20 may be configured using a computer, such as a personal computer or workstation. Alternatively, the decryption device 20 may be configured using dedicated hardware, such as configured using an ASIC or FPGA.

The following is an example of a case in which the cryptographic system 1 encrypts and decrypts text data. In this case, the encrypted data is referred to as ciphertext, and the unencrypted data (which may be decrypted data) is referred to as plaintext. However, the data to be encrypted and decrypted by the cryptographic system 1 is not limited to specific data, but can be a variety of data expressed in bit strings. For example, image or audio data, or a combination of both, may be subject to encryption and decryption by the cryptographic system 1.

The following also applies to the case where the cryptographic system 1 encrypts and decrypts data blocks using a tweakable block cipher.

The tweakable block cipher is a cipher that performs keyed substitutions including a tweak in the input of the block cipher. By using a different tweak for each data block, encryption can be performed in the same way as in a case where encryption is performed using a different key for each data block, and in this respect, the security of the cipher can be increased. The security of cryptography here is that it is difficult for a third party to decrypt the encrypted data.

The block cipher used in the tweakable block cipher corresponds to a cryptographic primitive. The cryptographic primitive here is the basic cipher or algorithm used for encryption and decryption.

However, the encryption scheme used by cryptographic system 1 to encrypt data blocks is not limited to a specific one, but can be a variety of encryption schemes that convert fixed-length data blocks into fixed-length data blocks.

In particular, the encryption scheme used by the cryptographic system 1 to encrypt data blocks is not limited to tweakable block ciphers. The cryptographic system 1 may use a block cipher (cryptographic primitive) that is not configured as a tweakable block cipher directly for encrypting data blocks.

The block ciphers used by the cryptographic system 1 as cryptographic primitives are not limited to those of a particular cipher scheme. For example, the cryptographic system 1 may use any of, but not limited to, Data Encryption Standard (DES), Triple DES, or Advanced Encryption Standard (AES) as a cryptographic primitive.

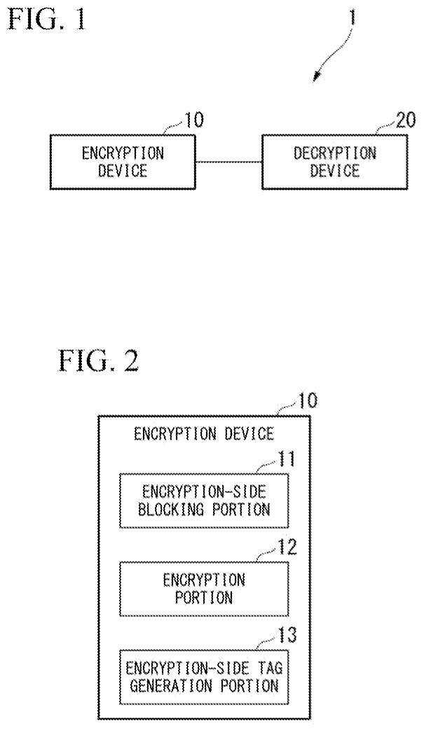

FIG. 2 is a drawing that show an example of the configuration of the encryption device 10. In the configuration shown in FIG. 2, the encryption device 10 has an encryption-side blocking portion 11, an encryption portion 12, and an encryption-side tag generation portion 13.

The encryption-side blocking portion 11 generates a sequence of blocks by dividing plain text into blocks of fixed length. Plain text here corresponds to the example of data to be encrypted.

The encryption-side blocking portion 11 is an example of a blocking means and an example of an encryption-side blocking means.

The encryption portion 12 encrypts each block included in the sequence of blocks generated by the encryption-side blocking portion 11 using the tweakable block cipher. The encryption portion 12 then concatenates the encrypted blocks to generate ciphertext. The concatenating of blocks here may be the putting together of bit strings as blocks into a single bit string by joining them together according to the order of the blocks in the sequence of blocks. The ciphertext here corresponds to an example of encrypted data.

The encryption portion 12 is an example of an encryption means.

The encryption-side tag generation portion 13 generates a tag for each block set in which the blocks in the sequence of blocks generated by the encryption-side blocking portion 11 are combined. Then, the encryption-side tag generation portion 13 concatenates the tags for each block set to generate the ciphertext tags. The encryption-side tag generation portion 13 is an example of a tag generation means and an example of an encryption-side tag generation means. The block set that the encryption-side tag generation portion 13 targets for tag generation is an example of the first block set.

The encryption-side tag generation portion 13 generates tags for each block set and concatenates the tags for each block set to generate ciphertext tags. The encryption-side tag generation portion 13 generates a tag for each block set, so that the block set is subject to detection of whether or not it has been tampered with. Therefore, by having the encryption-side tag generation portion 13 generate tags for a block set determined so that any block is included in at least one block set, the decryption device 20 can detect that tampering has taken place and the tampering location even if any position in the ciphertext (encrypted data) has been tampered with.

In addition, the encryption-side tag generation portion 13 generates a tag for a block set determined so that the decryption device 20 can identify the tampered block if the ciphertext is tampered with, whereby the decryption device 20 can detect the tampered location in block units. Specifically, a block set for which a tag was generated by the encryption-side tag generation portion 13 may be determined so that for any two blocks included in the same block set, there will always exist a block set that includes only one of those two blocks and not the other.

The technique for determining the block set so that tampered blocks can be identified may be, but is not limited to, using a combinatorial group testing method.

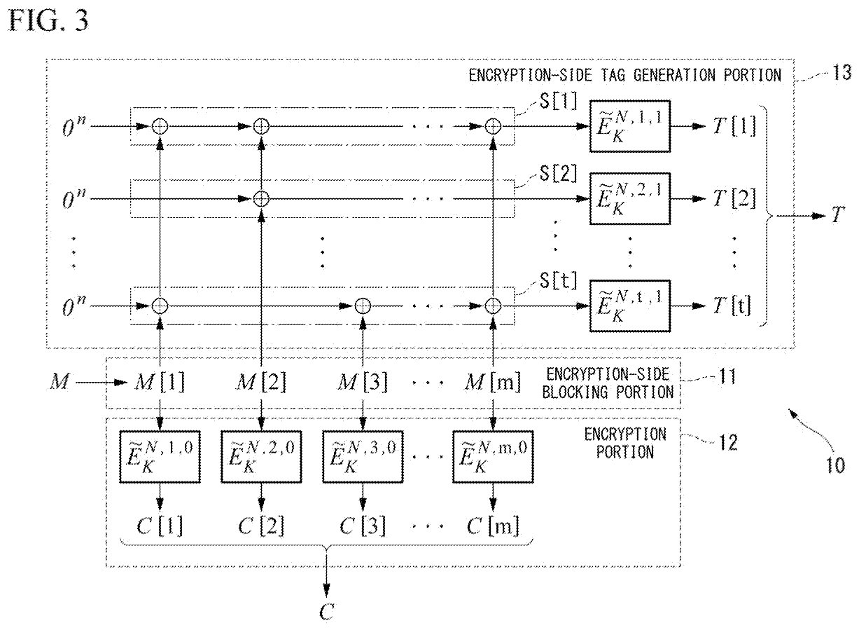

FIG. 3 is a drawing that shows an example of data flow in a case where the encryption device 10 encrypts plain text.

In the example in FIG. 3, the encryption-side blocking portion 11 divides the plain text M into m blocks M[1] to M[m].

As described above, the plain text M falls under the example of data to be encrypted. m is an integer representing the number of blocks that the cryptographic device 10 generates by dividing the plain text M, with m≥2.

m may be a fixed value. In this case, if the data size of the plain text to be encrypted is larger than the block length multiplied by m, the encryption-side blocking portion 11 may cut out the data of the data size of the block length×m, starting from the beginning of the plain text to be encrypted, and treat the cut-out data as plain text M. In a case where the data size of the plain text to be encrypted is smaller than the block length×m, the encryption-side blocking portion 11 may perform padding on the plain text to make the data size the block length×m.

The block length here is the data size of one block. Both data size and block length may be expressed in terms of bit length (number of bits as data in a bit string).

Alternatively, if the encryption-side tag generation portion 13 can determine the block set during tag generation, the encryption-side blocking portion 11 may determine the value of m in a case where the plain text to be encrypted is divided into blocks. In this case, the encryption-side blocking portion 11 may also perform padding as necessary.

The encryption-side blocking portion 11 outputs the sequence of blocks M[1] to M[m] to the encryption portion 12 and the encryption-side tag generation portion 13. The encryption portion 12 may cut out blocks from the beginning of the plain text M in sequence, and for each cut out block, output it to the encryption portion 12 and the encryption-side tag generation portion 13. Alternatively, the encryption portion 12 may divide the plain text M into blocks M[1] through M[m] and then output these m blocks together to the encryption portion 12 and the encryption-side tag generation portion 13.

The encryption portion 12 encrypts each of the blocks M[1] to M[m] using the tweakable block cipher.

The encrypted block M[i] is also denoted as block C[i]. Here, i is an integer 1≤i≤m.

The encryption portion 12 concatenates blocks C[1] through C[m] to generate ciphertext C.

The tweakable block cipher used by the cryptographic system 1 is also denoted as E˜_{K}^{N,i,j}. Here, i is an integer that identifies m blocks M[1] to [m], or an integer that identifies t block sets that are subject to tag generation, where 1≤i≤m. t is an integer that represents the number of tags, where 2≤t≤m.

In addition, j is an integer where 0≤j≤1. In a case where the encryption portion 12 performs encryption, j=0, and in a case where the encryption-side tag generation portion 13 generates the tag, j=1.

However, the values of i and j can be any value that provides a different bit sequence for each block to be encrypted and each block set targeted for tag generation, and are not limited to specific values.

K represents the key used for block ciphers (the common key shared by the encryption device 10 and the decryption device 20).

N represents a nonce (number used once). The nonce N is a disposable number where a different value is used for each encryption of plain text M.

The cryptographic system 1 uses a numerical value based on the combination of nonce N, i and j as tweak. For example, nonce N, i, and j may be represented by a bit length where the sum of these bit lengths equals the block length, and the cryptographic system 1 may use a single-bit sequence that concatenates nonce N, i, and j as a bit sequence in this order as tweak. This allows the encryption device 10 (encryption portion 12 and encryption-side tag generation portion 13) to use a different tweak for each execution of encryption with the tweakable block cipher, thus increasing the security of the cipher in this respect.

The encryption-side tag generation portion 13 generates a tag for each of the t block sets, which are combinations of one or more blocks from blocks M[1] to M[m].

In the example in FIG. 3, 0ⁿ represents a bit sequence with n bits of 0. n represents the block length. That is, n represents the bit length of block M[i]. Here, i is an integer where 1≤i≤m.

A “+” surrounded by a circle (“◯”) indicates exclusive disjunction. Specifically, the circled “+” represents the operation of bitwise exclusive OR of two bit strings. This exclusive OR is also denoted as XOR.

In the example in FIG. 3, the operations corresponding to the t block sets S[1] through S[t] are shown using XOR. For each block set, the encryption-side tag generation portion 13 calculates n-bit blocks by taking the bitwise exclusive OR for all blocks included in the block set. The encryption-side tag generation portion 13 then encrypts the block calculated based on the block set S[i] using the tweakable block cipher E˜_{K}^{N,i,1} to generate the tag T[i]. Here, i is an integer, where 1≤ i≤t.

The encryption-side tag generation portion 13 concatenates tags T[1] through T[t] in that order to generate the tag T for ciphertext C. The order of the tags T[1] to T[t] here (i.e., the order of the block sets S[1] to S[t]) is an example of a predetermined order for the block sets.

As described above for the cryptographic system 1, the encryption-side tag generation portion 13 may generate tags for each block set determined using the combinatorial group testing method, but it is not limited thereto.

If the block set is determined using the combinatorial group testing method, t<m. Therefore, the data size of tag T is smaller than that of the ciphertext C.

In a case where the encryption device 10 and the decryption device 20 are configured as communication devices, the encryption device 10 may transmit the ciphertext C and tag T to the decryption device 20.

Alternatively, the encryption device 10 may record the ciphertext C and tag T in memory. The memory in this case may be internal to the encryption device 10 or external to the encryption device 10.

It is also assumed that the encryption device 10 and decryption device 20 share each of the following information: the key K, the blocks in each block set, and the tweak for each tweakable block cipher.

For example, the nonce N, the blocks in each block set, and the identification number of the block set (from 1 to t) may be made public. In the above explanation, the index i in tag T[i] and the index i in the block set S[i] correspond to examples of identification numbers for block sets.

The key K may be shared in advance between the encryption device 10 and the decryption device 20. It may also be stipulated that the arrangement order of the blocks M[1] to M[m] in the plain text M shall be used as the identification number of the block (from 1 to m). In the above explanation, the index i of the plain text block M[i] and the index i of the ciphertext block (encrypted block) C[i] are examples of block identification numbers.

The value j, which is assigned to each of encryption and tag generation, may be predetermined as j=0 for encryption (and decryption) and j=1 for tag generation.

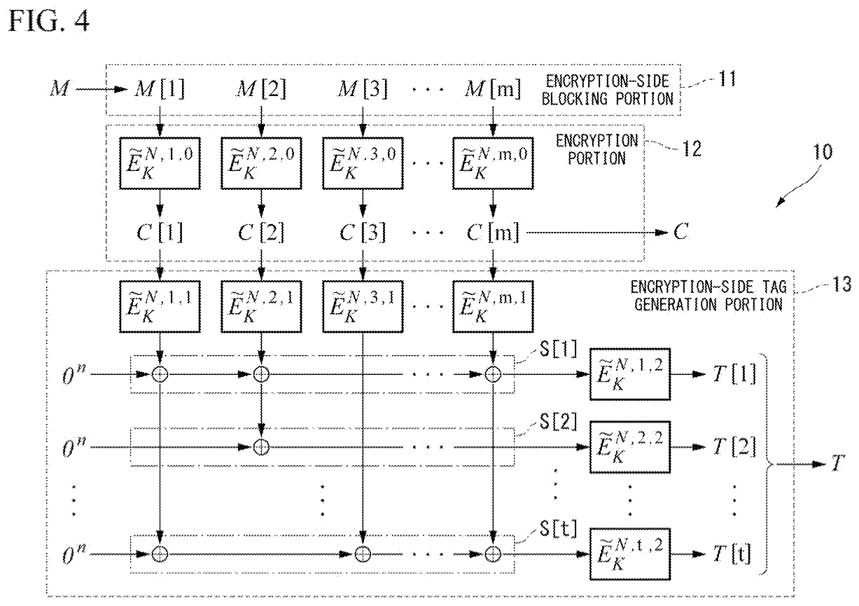

FIG. 4 is a drawing that shows an example of data flow in a case where the encryption device 10 generates tags using encrypted blocks.

FIG. 4 is shown for comparison with FIG. 3, but this does not preclude the encryption device 10 from performing the process shown in FIG. 4. If the encryption device 10 performs the process shown in FIG. 4, the decryption device 20, in the event of detecting that the ciphertext has been tampered with, can detect the tampering location.

In the example in FIG. 4, the encryption-side blocking portion 11 divides the plain text M into m blocks M[1] to M[m], as in FIG. 3. The encryption-side blocking portion 11 outputs the sequence of blocks M[1] to M[m] to the encryption portion 12.

On the other hand, in the example in FIG. 4, the encryption-side blocking portion 11 does not output the sequence of blocks M[1] to M[m] to the encryption-side tag generation portion 13.

As in FIG. 3, the encryption portion 12 encrypts each of the blocks M[1] to M[m] using a tweakable block cipher. The encryption portion 12 concatenates the encrypted blocks C[1] through C[m] to generate the ciphertext C.

In the example in FIG. 4, the encryption portion 12 outputs the sequence of encrypted blocks C[1] to C[m] to the encryption-side tag generation portion 13.

The encryption-side tag generation portion 13 uses the encrypted blocks C[1] through C[m] to generate the tag T for the ciphertext C.

In this case, from the viewpoint of cryptographic security, it is conceivable to further encrypt each of the encrypted blocks C[1] through C[m] as shown in FIG. 4, and also to perform encryption in a case where generating the tags for each block set.

In the example in FIG. 4, the encryption-side tag generation portion 13 encrypts each of the encrypted blocks C[1] through C[m] using the tweakable block cipher. The encryption-side tag generation portion 13 encrypts the block C[i] using the tweakable block cipher E˜_{K}^{N,i,1}. Here, i is an integer where 1≤i≤m. In the following, the block in which block C[i] is encrypted is also referred to as a doubly encrypted block and is also denoted as D[i].

For each block set where doubly encrypted blocks are combined, the encryption-side tag generation portion 13 calculates an n-bit block by taking the bitwise exclusive OR for all blocks in the block set. The encryption-side tag generation portion 13 then encrypts the calculated blocks for each block set using the tweakable block cipher to generate a tag for each block set. The encryption-side tag generation portion 13 encrypts the block set S[i] using the tweakable block cipher E˜_{K}^{N,i,2} to generate the tag T[i]. Here, i is an integer, where 1≤i≤t.

The encryption-side tag generation portion 13 concatenates the tags T[1] through T[t] for each block set to generate the tag T of the ciphertext C.

In the example in FIG. 4, the encryption-side tag generation portion 13 generates a tag for each block set of doubly encrypted blocks combined. In contrast, in the example in FIG. 3, the encryption-side tag generation portion 13 generates a tag for each block set of combined blocks of plain text.

In the example in FIG. 4, the encryption-side tag generation portion 13, in a case where generating tags for each block set, performs encryption using a tweakable block cipher with a different tweak than in a case where further encrypting the encrypted blocks. In contrast, in the example in FIG. 3, the encryption-side tag generation portion 13 does not further encrypt the encrypted block. Thus, in the example in FIG. 3, the concept of different tweaks does not arise in a case where generating tags for each block set and in a case where further encrypting the encrypted blocks, as in the case of the example in FIG. 4.

In general, the values of each tag from tag T[1] to T[t] and the value of tag T are different between the example in FIG. 3 and the example in FIG. 4.

Other than these points, the process by which the encryption-side tag generation portion 13 generates tag T in the example in FIG. 4 is the same as the process by which the encryption-side tag generation portion 13 generates tag T in the example in FIG. 3.

In the example in FIG. 4, the encryption-side tag generation portion 13 must generate the tag after the encryption portion 12 has encrypted the block. In contrast, in the example in FIG. 3, the process of encrypting the block by the encryption unit 12 and the process of generating tags by the encryption-side tag generation portion 13 can be executed in parallel.

In the example in FIG. 4, the encryption unit 10 performs encryption using the tweakable block cipher 2 m+t times. From this, the order of processing volume of the encryption device 10 in the example in FIG. 4 can be evaluated as O(2 m+t). If the encryption unit 10 performs successive iterations of encryption using the tweakable block cipher, the order of processing time for the encryption unit 10 in the example in FIG. 4 can be evaluated as O(2 m+t).

On the other hand, in the example in FIG. 3, the encryption unit 10 performs encryption using the tweakable block cipher m+t times. From this, the order of processing volume of the encryption device 10 in the example in FIG. 3 can be evaluated as O(m+t). If the encryption unit 10 performs successive iterations of encryption using the tweakable block cipher, the order of processing time of the encryption unit 10 in the example in FIG. 3 can be evaluated as O(m+t).

Thus, in both the example in FIG. 3 and the example in FIG. 4, the encryption device 10 can generate a tag T such that in a case where the decryption device 20 detects that the ciphertext has been tampered with, it can detect the tampering location.

In the example in FIG. 3, it is expected that the cryptographic device 10 can generate the ciphertext C and tag T in a shorter processing time than in the example in FIG. 4.

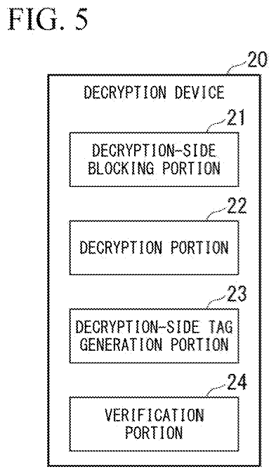

FIG. 5 shows an example of the configuration of the decryption device 20. In the configuration shown in FIG. 3, the decryption device 20 is provided with a decryption-side blocking portion 21, a decryption portion 22, a decryption-side tag generation portion 23, and a verification portion 24.

The decryption-side blocking portion 21 generates a sequence of blocks by dividing the ciphertext into blocks of fixed length. In particular, the decryption-side blocking portion 21 divides the ciphertext into blocks of the same bit length as the bit length of the encrypted block generated by the encryption portion 12. The ciphertext here corresponds to an example of data to be decrypted. The data to be decrypted is the data generated by the encryption portion 12 or the data generated by the encryption portion 12 that has been tampered with.

The decryption-side blocking portion 21 is an example of a blocking means and an example of a decryption-side blocking means.

The decryption portion 22 decrypts each block included in the sequence of blocks generated by decryption-side blocking portion 21 using a tweakable block cipher. The decryption portion 22 decrypts the blocks by a tweakable block cipher using the same tweak used for encryption by the encryption portion 12. The decryption portion 22 then concatenates the decrypted blocks to generate plain text. Plain text here corresponds to the example of decrypted data.

The decryption portion 22 is an example of a decryption means.

The decryption-side tag generation portion 23 generates a tag for each block set, which is a combination of blocks included in the sequence of blocks decrypted by the decryption portion 22. The decryption-side tag generation portion 23 then concatenates the tags for each block set to generate ciphertext tags.

The decryption-side tag generation portion 23 is an example of a tag generation means and an example of a decryption-side tag generation means. The block set that the decryption-side tag generation portion 23 targets for tag generation is an example of the second block set.

The ciphertext tag generated by the decryption-side tag generation portion 23 is also referred to as a tag of the data to be decrypted. On the other hand, the ciphertext tag generated by the encryption-side tag generation portion 13 is also referred to as a tag of the encrypted data. By comparing the tag of the data to be decrypted with the tag of the encrypted data, it is possible to detect whether or not the data to be decrypted has been tampered with, and if so, the location of the tampering.

The decryption-side tag generation portion 23 performs the same process to generate tags as the encryption-side tag generation portion 13 performs to generate tags. As a result, if the ciphertext has not been tampered with, the tag generated by the encryption-side tag generation portion 13 and the tag generated by the decryption-side tag generation portion 23 have the same value. On the other hand, if the ciphertext has been tampered with, the tag generated by the encryption-side tag generation portion 13 and the tag generated by the decryption-side tag generation portion 23 will have different values.

Based on the tag of the data to be decrypted and the tag of the encrypted data, the verification portion 24 detects whether or not the ciphertext, which is the data to be decrypted, has been tampered with, and in the case of detecting that tampering has occurred, detects the tampering location.

If the data to be decrypted has not been tampered with, the tag of the data to be decrypted and the tag of the encrypted data have the same value. On the other hand, if the data to be decrypted has been tampered with, the tag of the data to be decrypted and the tag of the encrypted data have the same value. Accordingly, the verification portion 24 can detect the presence of tampering by comparing the tag of the data to be decrypted with the tag of the encrypted data.

In addition, the ciphertext tag is constituted by concatenation of tags for each block set. If the data to be decrypted has been tampered with, for the block set including the block corresponding to the tampered location, the tag value of the block set differs between the tag of the data to be decrypted and the tag of the encrypted data.

This allows the verification portion 24 to detect tampering locations in units of block sets. If the block set is determined so that the blocks can be identified, the verification portion 24 can detect the location of the tampering on a block-by-block basis.

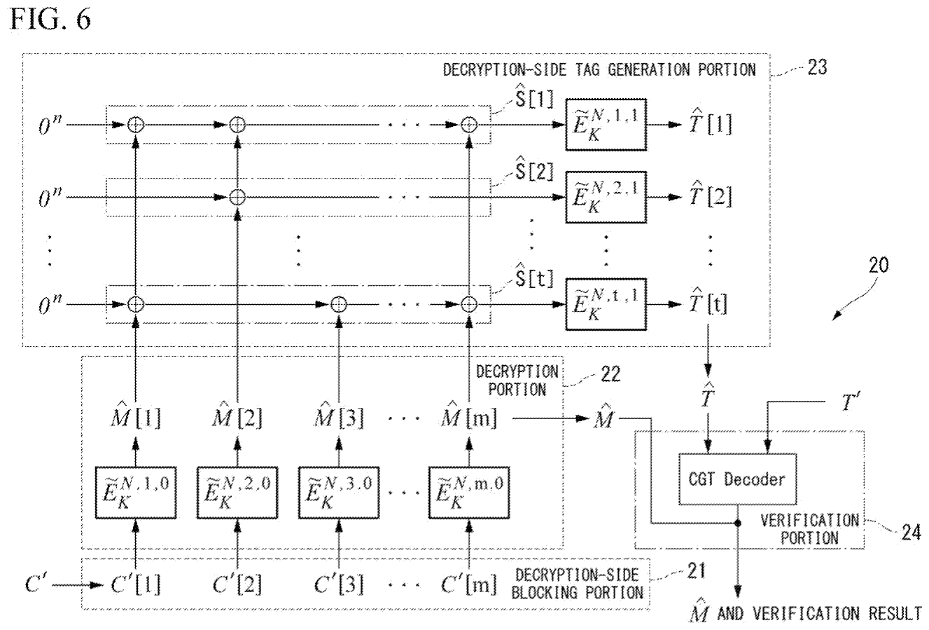

FIG. 6 shows an example of data flow in a case where the decryption device 20 decrypts ciphertext. In FIG. 6, the ciphertext, which is the data to be decrypted, is denoted as C′, and the blocks into which the ciphertext C′ is divided are denoted as C′[1], C′[2], . . . , C′[m]. The ciphertext C′ is the ciphertext C generated by the encryption device 10, or the ciphertext C that has been tampered with.

The block of plain text in which blocks C′[1], C′[2], . . . , C′[m] are decrypted is denoted as M\hat{ }[1], M\hat{ }[2], . . . , M\hat{ }[m], and the plain text in which blocks M\hat{ }[1] through M\hat{ }[m] are concatenated (decrypted plain text) is denoted as M\hat{ }.

The block set consisting of combinations of blocks in the sequence of blocks M\hat{ }[1] to M\hat{ }[m] is denoted S\hat{ }[1], S\hat{ }[2], . . . , S\hat{ }[t], and the tag in which blocks S\hat{ }[1] to S\hat{ }[m] are concatenated is denoted T\hat{ }.

The tag of ciphertext C′ is also denoted as T′. Tag T′ is the tag T generated by the cryptographic device 10, or the tag T that has been tampered with.

In the example in FIG. 6, the decryption-side blocking portion 21 divides the ciphertext C′ into m blocks C′[1] to C′[m]. The decryption-side blocking portion 21 divides the ciphertext C′, which has the same data size as the ciphertext C generated by the encryption portion 12, into blocks C′[1] to C′[m], which have the same number (m) and same block length as the blocks C[1] to C[m].

The decryption-side blocking portion 21 outputs the sequence of blocks C′[1] to C′[m] to the decryption portion 22.

The decryption portion 22 decrypts each block from C′[1] to C′[m] using a tweakable block cipher to generate blocks M\hat{ }[1] to M\hat{ }[m]. The decryption portion 22 decrypts the block C′[i] with a tweakable block cipher using the same key K and tweak(N,i,0) as the key K and tweak(N,i,0) used by encryption portion 12 to encrypt block M[i] corresponding to block M\hat{ }[i]. Here, i is an integer where 1≤ i≤ m.

Here, the first block corresponding to the second block means that their positions in the sequence of blocks in the original data (or concatenated data) are the same for the first and second blocks.

The decryption portion 22 concatenates the decrypted blocks M\hat{ }[1] through M\hat{ }[m] to generate the plain text M\hat{ }.

The decryption portion 22 outputs the sequence of blocks M\hat{ }[1] through M\hat{ }[m] to the decryption-side tag generation portion 23. The decryption portion 22 also outputs the plain text M\hat{ } to the verification portion 24.

The decryption-side tag generation portion 23 generates tags T\hat{ }[1] to T\hat{ }[t] for each of the t block sets in which one or more blocks from blocks M\hat{ }[1] to M\hat{ }[m] are combined. Then, the decryption-side tag generation portion 23 concatenates the tags T\hat{ }[1] through T\hat{ }[t] generated for each block set to generate a tag T\hat{ } for the data to be decrypted.

The decryption-side tag generation portion 23 performs a similar process to the one used by the encryption-side tag generation portion 13 to generate the tag T from the sequence of blocks M[1] to M[m] to generate the tag T\hat{ } from the sequence of blocks M\hat{ }[1] to M\hat{ }[m].

The decryption-side tag generation portion 23 outputs the generated tag T\hat{ } to the verification portion 24.

The verification portion 24 detects whether or not the ciphertext, which is the data to be decrypted, has been tampered with based on the tag T\hat{ } of the data to be decrypted and the tag T′ of the ciphertext C″, and in the event of detecting that tampering has occurred, it detects the tampering location.

As described above, by comparing the tags T\hat{ } and T′, the verification portion 24 can detect whether or not the ciphertext has been tampered with, and if tampering is detected, the location of the tampering can be detected.

As described above, the encryption-side blocking portion 11 generates a sequence of blocks by dividing the data to be encrypted into fixed-length blocks. The encryption portion 12 performs encryption using a block cipher for each block in the sequence of blocks into which the data to be encrypted is divided, and concatenates the encrypted blocks to generate the encrypted data. by encrypting the block The encryption-side tag generation portion 13 generates a tag for each block set, which is a combination of blocks included in a sequence of blocks into which the data to be encrypted is divided, and concatenates the tags for each block set to generate a tag for the encrypted data.

By using the tags generated by the encryption device 10, if the encrypted data is tampered with, it is possible to detect which blocks in which block set the tampering was done. According to the encryption device 10, in this respect, the tampering location can be detected in a case where tampering is performed on the encrypted data.

For each block set, the encryption-side tag generation portion 13 generates a tag for the block set by using a block cipher to encrypt a block generated by taking the bitwise exclusive OR for all blocks in the block set.

According to the encryption device 10, block ciphers can be used for both data encryption and tag generation. According to the encryption device 10, the configuration of the device can be simplified in this respect.

The block set is also determined so that any block in the sequence of blocks into which the data to be encrypted is divided is included in at least one block set. According to the encryption device 10, even if any part of the data to be encrypted is tampered with, it is possible to detect that tampering has taken place and the location of the tampering.

The block set is also determined so that for any two blocks in the same block set, there is always a block set that includes only one of those two blocks and not the other.

According to the encryption device 10, if tampering has occurred, the tampering location can be detected on a block-by-block basis.

The encryption portion 12 encrypts the blocks included in the sequence of blocks into which the data to be encrypted is divided using a tweakable block cipher constituted using a combination of a block cipher and a tweak. The encryption-side tag generation portion 13 encrypts blocks generated by taking the bitwise exclusive OR for all blocks in the block set using a tweakable block cipher constituted using a combination of a block cipher and tweak.

According to the encryption device 10, data encryption and tag generation can be performed using a tweakable block cipher. According to the encryption device 10, the security of the cipher can be increased in this respect.

The decryption-side blocking portion 21 divides the data to be decrypted into fixed-length blocks to generate a sequence of blocks. The decryption portion 22 decrypts each block included in the sequence of blocks into which the data to be decrypted has been divided, using a block cipher, and concatenates the decrypted blocks to generate the decrypted data. The decryption-side tag generation portion 23 generates a tag for each block set in which the blocks included in the decrypted block sequence are combined, and concatenates the tags for each block set to generate a tag for the data to be decrypted. The verification portion 24 detects the presence or absence of tampering in the data to be decrypted and the location of the tampering in a case where tampering is detected, based on the tags generated by the tag generation means and the tags generated during encryption.

According to decryption device 20, in a case where encrypted data is tampered with, it is possible to detect which blocks in which block set the tampering was performed. According to the decryption device 20, in this respect, if tampering with the encrypted data is performed, the tampering location can be detected.

For each block set, the decryption-side tag generation portion 23 generates a tag for the block set by using a block cipher to encrypt a block generated by taking the bitwise exclusive OR for all blocks in the block set.

According to the decryption device 20, a block cipher can be used for both data decryption and tag generation. According to the decryption device 20, the configuration of the device can be simplified in this respect.

The block set is also determined so that any block in the sequence of decrypted blocks is included in at least one block set.

According to the decryption device 20, even if any part of the data to be encrypted has been tampered with, it is possible to detect that tampering has taken place and the location of the tampering.

The block set is also determined so that for any two blocks in the same block set, there is always a block set that includes only one of those two blocks and not the other.

According to the decryption device 20, if tampering has occurred, the tampering location can be detected on a block-by-block basis.

The description portion 22 decrypts the blocks included in the sequence of blocks into which the data to be decrypted is divided using a tweakable block cipher constituted using a combination of a block cipher and a tweak. The decryption-side tag generation portion 23 encrypts blocks generated by taking the bitwise exclusive OR for all blocks in the block set using a tweakable block cipher constituted using a combination of a block cipher and tweak.

According to the decryption device 20, it is possible to detect whether or not data encrypted using a tweakable block cipher has been tampered with, and if so, the location of the tampering using tags generated by a tweakable block cipher. According to the decryption device 20, the security of the cipher can be increased in this respect.

### Second Example Embodiment

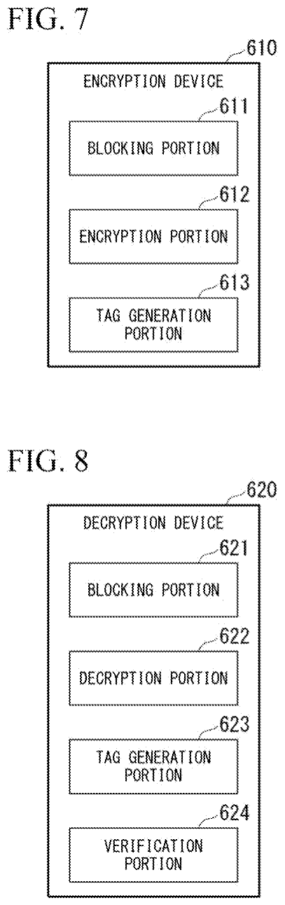

FIG. 7 is a drawing that shows another example of the configuration of an encryption device according to at least one example embodiment. In the configuration shown in FIG. 7, an encryption device 610 is provided with a blocking portion 611, an encryption portion 612, and a tag generation portion 613.

The blocking portion 611 generates a sequence of blocks by dividing the data to be encrypted into fixed-length blocks. The encryption portion 612 performs encryption using a block cipher for each block in the sequence of blocks into which the data to be encrypted is divided, and concatenates the encrypted blocks to generate the encrypted data. The tag generator 613 generates a tag for each block set, which is a combination of blocks included in a sequence of blocks into which the data to be encrypted is divided, and concatenates the tags for each block set to generate a tag for the encrypted data. The blocking portion 611 is an example of a blocking means. The encryption portion 612 is an example of an encryption means. The tag generation portion 613 is an example of a tag generation means.

By using the tags generated by the 610 encryption device, if the encrypted data is tampered with, it is possible to detect to which blocks within the block set the tampering was done. According to the encryption device 610, in this respect, the tampering location can be detected in a case where tampering is performed on the encrypted data.

### Third Example Embodiment

FIG. 8 is a drawing that shows another example of the configuration of a decryption device according to at least one example embodiment. In the configuration shown in FIG. 8, a decryption device 620 is provided with a blocking portion 621, a decryption portion 622, a tag generation portion 623, and a verification portion 624.

The blocking portion 621 generates a sequence of blocks by dividing the data to be decrypted into fixed-length blocks. The decryption portion 622 decrypts each block included in the sequence of blocks into which the data to be decrypted has been divided, using a block cipher, and concatenates the decrypted blocks to generate the decrypted data. The tag generation portion 623 generates a tag for each block set in which the blocks included in the decrypted block sequence are combined, and concatenates the tags for each block set to generate a tag for the data to be decrypted. The verification portion 624 detects the presence or absence of tampering in the data to be decrypted and the location of the tampering in a case where tampering is detected, based on the tags generated by the tag generation means and the tags generated during encryption.

The blocking portion 621 is an example of a blocking means. The decryption portion 622 is an example of a decryption means. The tag generation portion 623 is an example of a tag generation means. The verification portion 624 is an example of a verification means.

According to decryption device 620, in a case where encrypted data is tampered with, it is possible to detect which blocks in which block set the tampering was performed. According to the decryption device 620, in this respect, if tampering with the encrypted data is performed, the tampering location can be detected.

### Fourth Example Embodiment

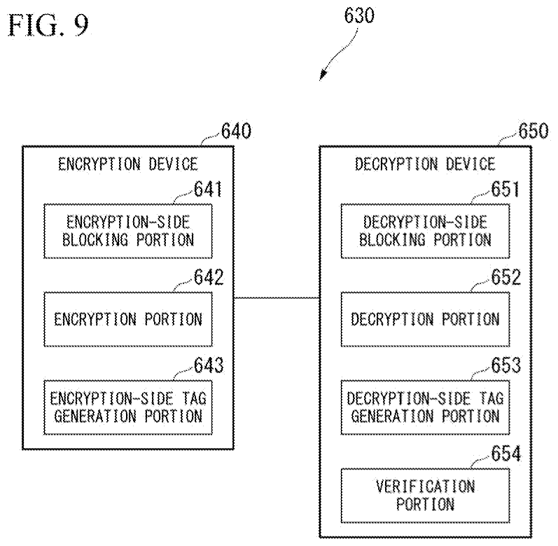

FIG. 9 is a drawing that shows another example of the configuration of the cryptographic system according to at least one example embodiment. In the configuration shown in FIG. 9, the cryptographic system 630 is provided with an encryption device 640 and a decryption device 650. The encryption device 640 is provided with an encryption-side blocking portion 641, an encryption portion 642, and an encryption-side tag generation portion 643. The decryption device 650 is provided with a decryption-side blocking portion 651, a decryption portion 652, a decryption-side tag generation portion 653, and a verification portion 654.

In such a configuration, the encryption-side blocking portion 641 generates a sequence of blocks by dividing the data to be encrypted into fixed-length blocks. The encryption portion 642 performs encryption using a block cipher for each block in the sequence of blocks into which the data to be encrypted is divided, and concatenates the encrypted blocks to generate the encrypted data. The encryption-side tag generation portion 643 generates a tag for each first block set, which is the block set that is a combination of blocks included in a sequence of blocks into which the data to be encrypted is divided, and concatenates the tags for each first block set to generate a tag for the encrypted data.

The decryption-side blocking portion 651 divides the data to be decrypted into fixed-length blocks to generate a sequence of blocks. The decryption portion 652 decrypts each block included in the sequence of blocks into which the data to be decrypted has been divided, using a block cipher, and concatenates the decrypted blocks to generate the decrypted data. The decryption-side tag generation portion 653 generates a tag for each second block set, which is the block set that is a combination of blocks included in the decrypted block sequence, and concatenates the tags for each second block set to generate a tag for the data to be decrypted. The verification portion 654 detects the presence or absence of tampering in the data to be decrypted and the location of the tampering in a case where tampering is detected, based on the tag of the data to be decrypted and the tag of the encrypted data.

The encryption-side blocking portion 641 is an example of an encryption-side blocking means. The encryption portion 642 is an example of an encryption means. The encryption-side tag generation portion 643 is an example of an encryption-side tag generation means. The decryption-side blocking portion 651 is an example of a decryption-side blocking means. The decryption portion 652 is an example of a decryption means. The decryption-side tag generation portion 653 is an example of a decryption-side tag generation means. The verification portion 654 is an example of a verification means.

According to cryptographic system 630, in a case where encrypted data is tampered with, it is possible to detect which blocks within a block set have been tampered with if the encrypted data is tampered with. According to the cryptographic system 630, in this respect, if tampering with encrypted data is performed, the tampering location can be detected.

### Fifth Example Embodiment

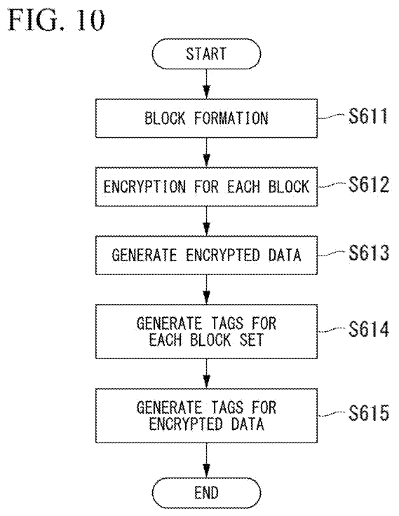

FIG. 10 is a drawing that shows an example of the processing steps in the encryption method according to at least one example embodiment. The process shown in FIG. 10 includes block formation (Step S611), performing encryption for each block (Step S612), generating encrypted data (Step S613), generating tags for each block set (Step S614), and generating tags for the encrypted data (Step S615).

In performing blocking (Step S611), the cryptographic device divides the data to be encrypted into blocks of fixed length to generate a sequence of blocks.

In performing block-by-block encryption (Step S612), the cryptographic device performs encryption using a block cipher for each block in the sequence of blocks into which the data to be encrypted is divided.

In generating encrypted data (Step S613), the cryptographic device concatenates the encrypted blocks to generate encrypted data.

In generating tags for each block set (Step S614), the cryptographic device generates a tag for each block set in which the blocks included in the sequence of blocks into which the data to be encrypted is divided are combined.

In generating tags for the encrypted data (Step S615), the cryptographic device concatenates the tags for each block set to generate tags for the encrypted data.

By using the tags generated by the encryption method shown in FIG. 10, if the encrypted data is tampered with, it is possible to detect to which blocks within the block set were tampered with. According to the encryption method shown in FIG. 10, in this respect, the tampering location can be detected in a case where tampering is performed on the encrypted data.

### Sixth Example Embodiment

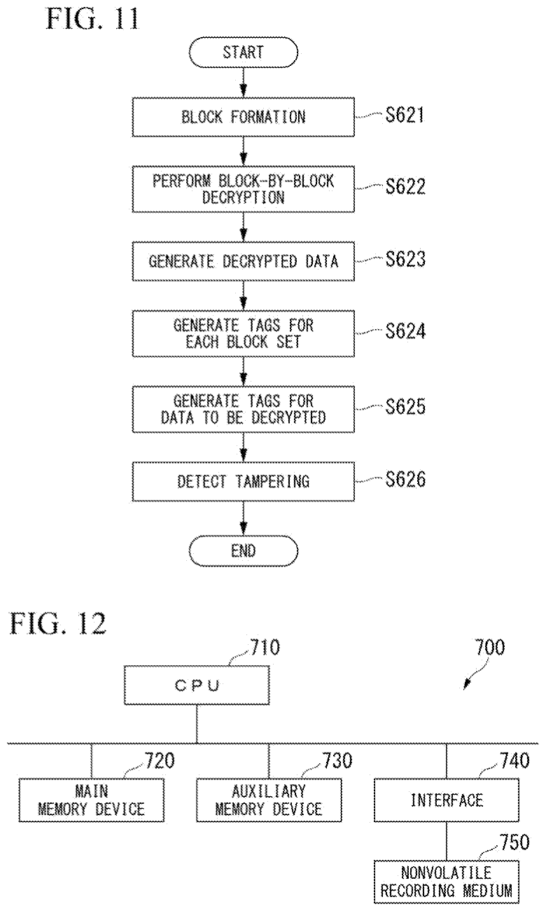

FIG. 11 is a drawing that shows an example of the processing steps in the decryption method according to at least one example embodiment. The decryption method shown in FIG. 11 includes block formation (Step S621), performing block-by-block decryption (Step 622), generating decrypted data (Step S623), generating tags for each block set (Step S624), generating tags for the data to be decrypted (Step S625), and detecting tampering (Step S626).

In performing blocking (Step S621), the decryption device divides the data to be decrypted into blocks of fixed length to generate a sequence of blocks.

In block-by-block decryption (Step 622), the decryption device performs decryption using a block cipher for each block in the sequence of blocks into which the data to be decrypted is divided.

In generating decrypted data (Step S623), the decryption device concatenates the decrypted blocks to generate decrypted data.

In generating tags for each block set (Step S624), the decryption device generates a tag for each block set in which the blocks in the decrypted block sequence are combined.

In generating tags for the data to be decrypted (Step S625), the decryption device concatenates the tags for each block set to generate tags for the data to be decrypted.

In detecting tampering (Step S626), the decryption device detects the presence or absence of tampering in the data to be decrypted and the tampering location in a case where tampering is detected based on the tag of the data to be decrypted and the tag generated during encryption.

According to decryption method shown in FIG. 11, in a case where encrypted data is tampered with, it is possible to detect which blocks in which block set the tampering was performed. According to the decryption method shown in FIG. 11, in this respect, the tampering location can be detected in a case where tampering is performed on the encrypted data.

FIG. 12 is a schematic block diagram showing the configuration of a computer according to at least one example embodiment.

In the configuration shown in FIG. 15, a computer 700 is provided with a CPU 710, a main memory device 720, an auxiliary memory device 730, an interface 740, and a nonvolatile recording medium 750.

Any one or more of the above encryption device 10, decryption device 20, encryption device 610, decryption device 620, encryption device 640, and decryption device 650, or any part thereof, may be implemented in the computer 700. In that case, the operations of each of the above-mentioned processing portions are stored in the auxiliary memory device 730 in the form of a program. The CPU 710 reads the program from the auxiliary storage device 730, deploys it in the main memory device 720, and executes the above processing according to the program. The CPU 710 also reserves a memory area in the main memory device 720 corresponding to each of the above-mentioned memory portions according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

In a case where the encryption device 10 is implemented in the computer 700, the operations of the encryption-side blocking portion 11, the encryption portion 12, and the encryption-side tag generation portion 13 are stored in the auxiliary storage device 730 in program form. The CPU 710 reads the program from the auxiliary storage device 730, deploys it in the main memory device 720, and executes the above processing according to the program.

The CPU 710 also allocates a storage area in the main memory device 720 for the encryption device 10 to perform processing according to the program. Communication between the encryption device 10 and other devices is performed by the interface 740, which has a communication function and communicates according to the control of the CPU 710. Interactions between the encryption device 10 and the user are performed by the interface 740 having an input device and an output device, presenting information to the user with the output device and accepting user operations with the input device according to the control of the CPU 710.

In a case where the decryption device 20 is implemented in the computer 700, the operations of the decryption-side blocking portion 21, the decryption portion 22, the decryption-side tag generation portion 23, and the verification portion 24 are stored in the auxiliary memory device 730 in the form of programs. The CPU 710 reads the program from the auxiliary storage device 730, deploys it in the main memory device 720, and executes the above processing according to the program.

The CPU 710 also allocates a storage area in the main memory device 720 for the decryption device 20 to perform processing according to the program. Communication between the decryption device 20 and other devices is performed by the interface 740, which has a communication function and communicates according to the control of the CPU 710. Interactions between the decryption device 20 and the user are performed by the interface 740 having an input device and an output device, presenting information to the user with the output device and accepting user operations with the input device according to the control of the CPU 710.

In a case where the encryption device 610 is implemented in the computer 700, the operations of the blocking portion 611, the encryption portion 612, and the tag generation portion 613 are stored in the auxiliary storage device 730 in the form of programs. The CPU 710 reads the program from the auxiliary storage device 730, deploys it in the main memory device 720, and executes the above processing according to the program.

The CPU 710 also allocates a storage area in the main memory device 720 for the encryption device 610 to perform processing according to the program. Communication between the encryption device 610 and other devices is performed by the interface 740, which has a communication function and communicates according to the control of the CPU 710. Interactions between the encryption device 610 and the user are performed by the interface 740 having an input device and an output device, presenting information to the user with the output device and accepting user operations with the input device according to the control of the CPU 710.

In a case where the decryption device 620 is implemented in the computer 700, the operations of the blocking portion 621, the decryption portion 622, the tag generation portion 623, and the verification portion 624 are stored in the auxiliary memory device 730 in the form of programs. The CPU 710 reads the program from the auxiliary storage device 730, deploys it in the main memory device 720, and executes the above processing according to the program.

The CPU 710 also allocates a storage area in the main memory device 720 for the decryption device 620 to perform processing according to the program. Communication between the decryption device 620 and other devices is performed by the interface 740, which has a communication function and communicates according to the control of the CPU 710. Interactions between the decryption device 620 and the user are performed by the interface 740 having an input device and an output device, presenting information to the user with the output device and accepting user operations with the input device according to the control of the CPU 710.

In a case where the encryption device 640 is implemented in the computer 700, the operations of the encryption-side blocking portion 641, the encryption portion 642, and the encryption-side tag generation portion 643 are stored in the auxiliary storage device 730 in program form. The CPU 710 reads the program from the auxiliary storage device 730, deploys it in the main memory device 720, and executes the above processing according to the program.

The CPU 710 also allocates a storage area in the main memory device 720 for the encryption device 640 to perform processing according to the program. Communication between the encryption device 640 and other devices is performed by the interface 740, which has a communication function and communicates according to the control of the CPU 710. Interactions between the encryption device 640 and the user are performed by the interface 740 having an input device and an output device, presenting information to the user with the output device and accepting user operations with the input device according to the control of the CPU 710.

In a case where the decryption device 650 is implemented in the computer 700, the operations of the decryption-side blocking portion 651, the decryption portion 652, the decryption-side tag generation portion 653, and the verification portion 654 are stored in the auxiliary memory device 730 in the form of programs. The CPU 710 reads the program from the auxiliary storage device 730, deploys it in the main memory device 720, and executes the above processing according to the program.

The CPU 710 also allocates a storage area in the main memory device 720 for the decryption device 650 to perform processing according to the program. Communication between the decryption device 650 and other devices is performed by the interface 740, which has a communication function and communicates according to the control of the CPU 710. Interactions between the decryption device 650 and the user are performed by the interface 740 having an input device and an output device, presenting information to the user with the output device and accepting user operations with the input device according to the control of the CPU 710.

Any one or more of the above programs may be recorded on a nonvolatile recording medium 750. In this case, the interface 740 may read the program from the nonvolatile recording medium 750. The CPU 710 may then directly execute the program read by the interface 740, or it may be stored once in the main memory device 720 or the auxiliary memory device 730 and then executed.

A program for executing all or part of the processes performed by the encryption device 10, the decryption device 20, the encryption device 610, the decryption device 620, the encryption device 640, and the decryption device 650 may be recorded on a computer-readable recording medium, and the program recorded on this recording medium may be read into a computer system and executed to perform the processing of each part. The term “computer system” here shall include operating systems (OS) and hardware such as peripheral devices.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

While preferred example embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

Some or all of the above example embodiments may also be described as, but not limited to, the following Supplementary Notes.

### (Supplementary Note 1)

An encryption means provided with:
a blocking means that generates a sequence of blocks by dividing data to be encrypted into blocks of fixed length;
an encryption means that performs encryption using a block cipher for each block in the sequence of blocks into which the data to be encrypted is divided, and concatenates the encrypted blocks to generate encrypted data; and
a tag generation means that generates a tag for each block set, which is a combination of blocks included in the sequence of blocks into which the data to be encrypted is divided, and concatenates the tags for each block set to generate a tag for the encrypted data.

### (Supplementary Note 2)

The encryption device according to Supplementary Note 1,
wherein the tag generation means, for each block set, generates a tag for the block set by encrypting a block generated by taking the bitwise exclusive OR for all blocks in the block set using a block cipher.

### (Supplementary Note 3)

The encryption device according to Supplementary Note 2,
wherein the block set is also determined so that any block in the sequence of blocks into which the data to be encrypted is divided is included in at least one block set.

### (Supplementary Note 4)

The encryption device according to Supplementary Note 2 or Supplementary Note 3,
wherein the block set is also determined so that for any two blocks in the same block set, there is always a block set that includes only one of those two blocks and not the other.

### (Supplementary Note 5)

The encryption device according to any one of Supplementary Note 2 to Supplementary Note 4,
wherein the encryption means encrypts blocks included in the sequence of blocks into which the data to be encrypted is divided using a tweakable block cipher constituted using a combination of the block cipher and a tweak; and
the tag generation means encrypts blocks generated by taking the bitwise exclusive OR for all blocks in the block set using a tweakable block cipher constituted using a combination of the block cipher and a tweak.

### (Supplementary Note 6)

A decryption device provided with:
a blocking means that generates a sequence of blocks by dividing data to be decrypted into blocks of fixed length;
a decryption means that decrypts each block included in the sequence of blocks into which the data to be decrypted has been divided, using a block cipher, and concatenates the decrypted blocks to generate the decrypted data;
a tag generation means that generates a tag for each block set in which the blocks included in the decrypted block sequence are combined, and concatenates the tags for each block set to generate a tag for the data to be decrypted; and
a verification means that detects the presence or absence of tampering in the data to be decrypted and the location of the tampering in a case where tampering is detected, based on the tags generated by the tag generation means and the tags generated during encryption.

### (Supplementary Note 7)

The decryption device according to Supplementary Note 6,
wherein the tag generation means, for each block set, generates a tag for the block set by encrypting a block generated by taking the bitwise exclusive OR for all blocks in the block set using a block cipher.

### (Supplementary Note 8)

The decryption device according to Supplementary Note 7,
wherein the block set is determined so that any block in the sequence of decrypted blocks is included in at least one block set.

### (Supplementary Note 9)

The decryption device as described in Supplementary Note 7 or Supplementary Note 8,
wherein the block set is determined so that for any two blocks in the same block set, there is always a block set that includes only one of those two blocks and not the other.

### (Supplementary Note 10)

The decryption device according to any one of Supplementary Note 7 to Supplementary Note 9,
wherein the decryption means decrypts blocks included in the sequence of blocks into which the data to be decrypted is divided using a tweakable block cipher constituted using a combination of the block cipher and a tweak; and
the tag generation means encrypts blocks generated by taking the bitwise exclusive OR for all blocks in the block set using a tweakable block cipher constituted using a combination of the block cipher and a tweak.

### (Supplementary Note 11)

An encryption system provided with an encryption device and a decryption device,
wherein the encryption device comprises:
an encryption-side blocking means that generates a sequence of blocks by dividing data to be encrypted into blocks of fixed length;
an encryption means that performs encryption using a block cipher for each block in the sequence of blocks into which the data to be encrypted is divided, and concatenates the encrypted blocks to generate encrypted data; and
an encryption-side tag generation means that generates a tag for each first block set, which is a block set that is a combination of blocks included in a sequence of blocks into which the data to be encrypted is divided, and concatenates the tags for each first block set to generate a tag for the encrypted data,
and the decryption device comprises:
a decryption-side blocking means that generates a sequence of blocks by dividing data to be decrypted into blocks of fixed length;
a decryption means that decrypts each block included in the sequence of blocks into which the data to be decrypted has been divided, using a block cipher, and concatenates the decrypted blocks to generate decrypted data;
a decryption-side tag generation means that generates a tag for each second block set, which is a block set that is a combination of blocks included in the decrypted block sequence, and concatenates the tags for each second block set to generate a tag for the data to be decrypted; and
a verification means that detects the presence or absence of tampering in the data to be decrypted and the location of the tampering in a case where tampering is detected, based on the tag of the data to be decrypted and the tag of the encrypted data.

### (Supplementary Note 12)

The encryption system according to Supplementary Note 11,
wherein the encryption-side tag generation means, for each of the first block sets, generates a tag for the first block set by using a block cipher to encrypt a block generated by taking the bitwise exclusive OR for all blocks in the block set, and the decryption-side tag generation means, for each of the second block sets, generates a tag for the second block set by using a block cipher to encrypt a block generated by taking the bitwise exclusive OR for all blocks in the block set.

### (Supplementary Note 13)

The encryption device according to Supplementary Note 12,
wherein the first block set is determined so that any block in the sequence of blocks into which the data to be encrypted is divided is included in at least one first block set; and
the second block set is determined such that any block in the sequence of decrypted blocks is included in at least one second block set.

### (Supplementary Note 14)

The encryption device according to Supplementary Note 12 or Supplementary Note 13,
wherein the first block set is determined such that for any two blocks in the same first block set, there is always a first block set that includes only one of those two blocks and not the other; and
the second block set is determined such that for any two blocks in the same second block set, there is always a second block set that includes only one of those two blocks and not the other.

### (Supplementary Note 15)

The encryption device according to any one of Supplementary Note 12 to Supplementary Note 14,
wherein the encryption means encrypts blocks included in the sequence of blocks into which the data to be encrypted is divided using a tweakable block cipher constituted using a combination of the block cipher and a tweak;
the encryption-side tag generation means encrypts blocks generated by taking the bitwise exclusive OR for all blocks in the first block set using a tweakable block cipher constituted using a combination of the block cipher and a tweak, and the decryption means decrypts blocks included in the sequence of blocks into which the data to be decrypted is divided using a tweakable block cipher constituted using a combination of the block cipher and a tweak; and
the decryption-side tag generation means encrypts blocks generated by taking the bitwise exclusive OR for all blocks in the second block set using a tweakable block cipher constituted using a combination of the block cipher and a tweak.

### (Supplementary Note 16)

An encryption method including the steps of an encryption device:
generating a sequence of blocks by dividing data to be encrypted into blocks of fixed length;
performing encryption using a block cipher for each block in the sequence of blocks into which the data to be encrypted is divided;
concatenating the encrypted blocks to generate encrypted data;
generating a tag for each block set in which the blocks included in the sequence of blocks into which the data to be encrypted is divided are combined; and
concatenating the tags for each block set to generate tags of the encrypted data.

### (Supplementary Note 17)

The encryption method according to Supplementary Note 16,
wherein in generating a tag for each block set, the tag is generated for the block set by using a block cipher to encrypt a block generated by taking the bitwise exclusive OR for all blocks in the block set.

### (Supplementary Note 18)

The encryption method according to Supplementary Note 17,
wherein the block set is determined so that any block in the sequence of blocks into which the data to be encrypted is divided is included in at least one block set.

### (Supplementary Note 19)

The encryption method according to Supplementary Note 17 or Supplementary Note 18,
wherein the block set is determined so that for any two blocks in the same block set, there is always a block set that includes only one of those two blocks and not the other.

### (Supplementary Note 20)

The encryption method according to any one of Supplementary Note 17 to Supplementary Note 19,
wherein in performing the encryption, a tweakable block cipher constituted using a combination of the block cipher and a tweak is used to encrypt blocks included in the sequence of blocks into which the data to be encrypted is divided; and
in generating the tag for each block set, a tweakable block cipher constituted using a combination of the block cipher and a tweak is used to encrypts blocks generated by taking the bitwise exclusive OR for all blocks in the block set.

### (Supplementary Note 21)

A decryption method comprising the steps of a decryption device:
generating a sequence of blocks by dividing data to be decrypted into blocks of fixed length;
performing decryption using a block cipher for each block in the sequence of blocks into which the data to be decrypted is divided;
concatenating the decrypted blocks to generate decrypted data;
generating a tag for each block set in which the blocks included in the sequence of decrypted blocks are combined; and
concatenating the tags for each block set to generate tags for the data to be decrypted, and based on the tags for the data to be decrypted and tags generated during encryption, detecting the presence or absence of tampering in the data to be decrypted and the tampering location in a case where tampering is detected.

### (Supplementary Note 22)

The decryption method according to Supplementary Note 21,
wherein in generating a tag for each block set, the tag is generated for the block set by using a block cipher to encrypt a block generated by taking the bitwise exclusive OR for all blocks in the block set.

### (Supplementary Note 23)

The decryption method according to Supplementary Note 22,
wherein the block set is determined so that any block in the sequence of decrypted blocks is included in at least one block set.

### (Supplementary Note 24)

The decryption method according to Supplementary Note 22 or Supplementary Note 23,
wherein the block set is determined so that for any two blocks in the same block set, there is always a block set that includes only one of those two blocks and not the other.

### (Supplementary Note 25)

The decryption method according to any one of Supplementary Note 22 to Supplementary Note 24,
wherein in performing the decryption, a tweakable block cipher constituted using a combination of the block cipher and a tweak is used to decrypt blocks included in the sequence of blocks into which the data to be decrypted is divided; and
in generating the tag for each block set, a tweakable block cipher constituted using a combination of the block cipher and a tweak is used to encrypts blocks generated by taking the bitwise exclusive OR for all blocks in the block set.

### (Supplementary Note 26)

A program that causes a computer to execute the steps of:
generating a sequence of blocks by dividing data to be encrypted into blocks of fixed length, and performing encryption using a block cipher for each block in the sequence of blocks into which the data to be encrypted is divided;
concatenating the encrypted blocks to generate encrypted data;
generating a tag for each block set in which the blocks included in the sequence of blocks into which the data to be encrypted is divided are combined; and
concatenating the tags for each block set to generate tags of the encrypted data.

### (Supplementary Note 27)

The program according to Supplementary Note 26,
wherein in generating a tag for each block set, the generation of the tag for the block set is executed by using a block cipher to encrypt a block generated by taking the bitwise exclusive OR for all blocks in the block set.

### (Supplementary Note 28)

The program according to Supplementary Note 27,
wherein the block set is determined such that any block in the sequence of blocks into which the data to be encrypted is divided is included in at least one block set.

### (Supplementary Note 29)

The program according to Supplementary Note 27 or Supplementary Note 28,
wherein the block set is determined so that for any two blocks in the same block set, there is always a block set that includes only one of those two blocks and not the other.

### (Supplementary Note 30)

The program according to any one of Supplementary Note 27 to Supplementary Note 29,
wherein in performing the encryption, a tweakable block cipher constituted using a combination of the block cipher and a tweak is used to execute encryption of blocks included in the sequence of blocks into which the data to be encrypted is divided; and
in generating the tag for each block set, a tweakable block cipher constituted using a combination of the block cipher and a tweak is used to execute encryption of blocks generated by taking the bitwise exclusive OR for all blocks in the block set.

### (Supplementary Note 31)

A program that causes a computer to execute the steps of:
generating a sequence of blocks by dividing data to be decrypted into blocks of fixed length;
performing decryption using a block cipher for each block in the sequence of blocks into which the data to be decrypted is divided, and concatenating the decrypted blocks to generate decrypted data;
generating a tag for each block set in which the blocks included in the sequence of decrypted blocks are combined;
concatenating the tags for each block set to generate tags of the decrypted data; and
detecting the presence or absence of tampering in the data to be decrypted and the tampering location in a case where tampering is detected based on the tag of the data to be decrypted and the tag generated during encryption.

### (Supplementary Note 32)

The program according to Supplementary Note 31,
wherein in generating a tag for each block set, the generation of the tag for the block set is executed by using a block cipher to encrypt a block generated by taking the bitwise exclusive OR for all blocks in the block set.

### (Supplementary Note 33)

The program according to Supplementary Note 32,
wherein the block set is determined so that any block in the sequence of decrypted blocks is included in at least one block set.

### (Supplementary Note 34)

The program according to Supplementary Note 32 or Supplementary Note 33,
wherein the block set is determined so that for any two blocks in the same block set, there is always a block set that includes only one of those two blocks and not the other.

### (Supplementary Note 35)

The program according to any one of Supplementary Note 32 to Supplementary Note 34,
wherein in performing the decryption, a tweakable block cipher constituted using a combination of the block cipher and a tweak is used to execute decryption of blocks included in the sequence of blocks into which the data to be decrypted is divided; and
in generating the tag for each block set, a tweakable block cipher constituted using a combination of the block cipher and a tweak is used to execute encryption of blocks generated by taking the bitwise exclusive OR for all blocks in the block set.

What is claimed is:

1. An encryption device comprising:
at least one memory configured to store instructions; and
at least one processor configured to execute the instructions to:
generate a sequence of blocks by dividing data to be encrypted into blocks of fixed length;
perform encryption using a block cipher for each block in the sequence of blocks into which the data to be encrypted is divided, and concatenate the encrypted blocks to generate encrypted data; and
generate a tag for each block set, which is a combination of blocks included in the sequence of blocks into which the data to be encrypted is divided, and concatenate the tags for each block set to generate a tag for the encrypted data.

2. The encryption device according to claim 1, wherein the at least one processor is configured to, for each block set, generate a tag for the block set by encrypting a block generated by taking the bitwise exclusive OR for all blocks in the block set using a block cipher.

3. The encryption device according to claim 2, wherein the block set is also determined so that any block in the sequence of blocks into which the data to be encrypted is divided is included in at least one block set.

4. The encryption device according to claim 2, wherein the block set is determined so that for any two blocks in the same block set, there is always a block set that includes only one of those two blocks and not the other.

5. The encryption device according to claim 2, wherein the at least one processor is configured to:
encrypt blocks included in the sequence of blocks into which the data to be encrypted is divided using a tweakable block cipher constituted using a combination of the block cipher and a tweak; and
encrypt blocks generated by taking the bitwise exclusive OR for all blocks in the block set using a tweakable block cipher constituted using a combination of the block cipher and a tweak.

6. A decryption device comprising:
at least one memory configured to store instructions; and
at least one processor configured to execute the instructions to:
generate a sequence of blocks by dividing data to be decrypted into blocks of fixed length;
decrypt each block included in the sequence of blocks into which the data to be decrypted has been divided, using a block cipher, and concatenate the decrypted blocks to generate decrypted data;
generate a tag for each block set in which the blocks included in the decrypted block sequence are combined, and concatenate the tags for each block set to generate a tag for the data to be decrypted; and
detect the presence or absence of tampering in the data to be decrypted and the location of the tampering in a case where tampering is detected, based on the generated tags and the tags generated during encryption.

7. The decryption device according to claim 6, wherein the at least one processor is configured to execute the instructions to, for each block set, generate a tag for the block set by encrypting a block generated by taking the bitwise exclusive OR for all blocks in the block set using a block cipher.

8. The decryption device according to claim 7, wherein the block set is determined so that any block in the sequence of decrypted blocks is included in at least one block set.

9. The decryption device according to claim 7, wherein the block set is determined so that for any two blocks in the same block set, there is always a block set that includes only one of those two blocks and not the other.

10. The decryption device according to claim 7, wherein the at least one processor is configured to execute the instructions to:
decrypt blocks included in the sequence of blocks into which the data to be decrypted is divided using a tweakable block cipher constituted using a combination of the block cipher and a tweak; and
encrypt blocks generated by taking the bitwise exclusive OR for all blocks in the block set using a tweakable block cipher constituted using a combination of the block cipher and a tweak.

11. An encryption system comprising an encryption device and a decryption device,
wherein the encryption device comprises:
at least one first memory configured to store first instructions; and
at least one first processor configured to execute the first instructions to:
generate a sequence of blocks by dividing data to be encrypted into blocks of fixed length;
perform encryption using a block cipher for each block in the sequence of blocks into which the data to be encrypted is divided, and concatenate the encrypted blocks to generate encrypted data; and
generate a tag for each first block set, which is a block set that is a combination of blocks included in a sequence of blocks into which the data to be encrypted is divided, and concatenate the tags for each first block set to generate a tag for the encrypted data,
and the decryption device comprises:
at least one second memory configured to store second instructions; and
at least one second processor configured to execute the second instructions to:
generate a sequence of blocks by dividing data to be decrypted into blocks of fixed length;
decrypt each block included in the sequence of blocks into which the data to be decrypted has been divided, using a block cipher, and concatenate the decrypted blocks to generate decrypted data;
generate a tag for each second block set, which is a block set that is a combination of blocks included in the decrypted block sequence, and concatenate the tags for each second block set to generate a tag for the data to be decrypted; and
detect the presence or absence of tampering in the data to be decrypted and the location of the tampering in a case where tampering is detected, based on the tag of the data to be decrypted and the tag of the encrypted data.

12. The encryption system according to claim 11, wherein the at least one first processor is configured to execute the first instructions to, for each of the first block sets, generate a tag for the first block set by using a block cipher to encrypt a block generated by taking the bitwise exclusive OR for all blocks in the block set, and
the at least second processor is configured to execute the second instructions to, for each of the second block sets, generate a tag for the second block set by using a block cipher to encrypt a block generated by taking the bitwise exclusive OR for all blocks in the block set.

13. The encryption device according to claim 12, wherein the first block set is determined so that any block in the sequence of blocks into which the data to be encrypted is divided is included in at least one first block set, and the second block set is determined such that any block in the sequence of decrypted blocks is included in at least one second block set.

14. The encryption device according to claim 12, wherein the first block set is determined such that for any two blocks in the same first block set, there is always a first block set that includes only one of those two blocks and not the other, and the second block set is determined such that for any two blocks in the same second block set, there is always a second block set that includes only one of those two blocks and not the other.

15. The encryption device according to claim 12, wherein the at least one first processor is configured to execute the instructions to:
encrypt blocks included in the sequence of blocks into which the data to be encrypted is divided using a tweakable block cipher constituted using a combination of the block cipher and a tweak;
encrypt blocks generated by taking the bitwise exclusive OR for all blocks in the first block set using a tweakable block cipher constituted using a combination of the block cipher and a tweak, and
the at least one second processor is configured to execute the instructions to:
decrypt blocks included in the sequence of blocks into which the data to be decrypted is divided using a tweakable block cipher constituted using a combination of the block cipher and a tweak; and
encrypt blocks generated by taking the bitwise exclusive OR for all blocks in the second block set using a tweakable block cipher constituted using a combination of the block cipher and a tweak.

16. An encryption method for controlling an encryption device, the method comprising:
generating a sequence of blocks by dividing data to be encrypted into blocks of fixed length;
performing encryption using a block cipher for each block in the sequence of blocks into which the data to be encrypted is divided;
concatenating the encrypted blocks to generate encrypted data;
generating a tag for each block set in which the blocks included in the sequence of blocks into which the data to be encrypted is divided are combined; and
concatenating the tags for each block set to generate tags of the encrypted data.

17. A decryption method for controlling a decryption device, the method comprising:
generating a sequence of blocks by dividing data to be decrypted into blocks of fixed length;
performing decryption using a block cipher for each block in the sequence of blocks into which the data to be decrypted is divided;
concatenating the decrypted blocks to generate decrypted data;
generating a tag for each block set in which the blocks included in the sequence of decrypted blocks are combined; and
concatenating the tags for each block set to generate tags for the data to be decrypted, and based on the tags for the data to be decrypted and tags generated during encryption, detecting the presence or absence of tampering in the data to be decrypted and the tampering location in a case where tampering is detected.
